(19) United States
(12) Patent Application Publication
(10) Pub. No.: US 2017/0255789 A1
(43) Pub. Date: Sep. 7, 2017

(54) METHOD FOR ACTIVATING FUNCTIONS IN A RADIO RECEIVER

(71) Applicant: Siemens Aktiengesellschaft, München (DE)

(72) Inventor: Rainer Falk, Poing (DE)

(21) Appl. No.: 15/504,059

(22) PCT Filed: Aug. 11, 2015
(86) PCT No.: PCT/EP2015/068428

§ 371 Date: Feb. 15, 2017

(30) Foreign Application Priority Data
Aug. 27, 2014 (DE) 10 2014 217 027.3

(51) Int. Cl. G06F 21/62; G01S 19/14; G01S 5/02; H04L 29/06

(52) U.S. Cl. CPC G06F 21/629; H04L 63/1466; G01S 19/14; G01S 5/0205; H04W 84/12

(57) ABSTRACT

A method for activating functions in a radio receiver is provided. The radio receiver detects a radio signal portion by recording, over a predetermined period of time, one or more received radio signals of a radio system, wherein a location and/or time information is assigned to the radio signal portion, which represents the location of the radio receiver upon receipt of the radio signal or radio signals, and which can. The radio receiver converts the radio signal portion into a communication signal, which is transmitted to a server via a communication network. In the server, it is then determined, if the location information and/or time information assigned to the radio signal portion is within a permissible range. If this is the case, the server sends an activation code, whereupon an activation of one or more functions is triggered in the radio receiver.

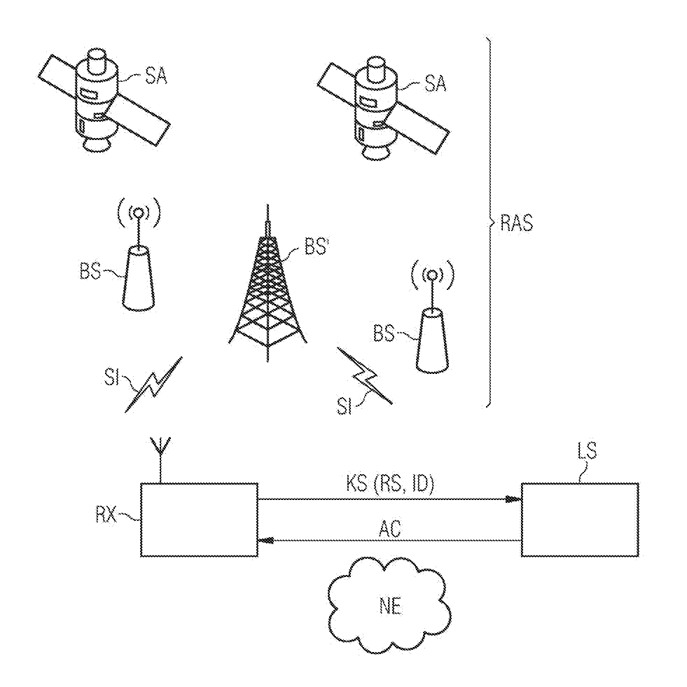

### CROSS-REFERENCE TO RELATED APPLICATIONS

This application claims priority to German application No. DE 102014217027.3 having a filing date of Aug. 27, 2014, the entire contents of which are hereby incorporated by reference.

### FIELD OF TECHNOLOGY

The following relates to a method and a system for activating functions in a radio receiver.

### BACKGROUND

The known art discloses the practice of using geofencing to restrict the use of a device to a particular admissible geographical region or possibly also an admissible period. To this end, the device has a position finding apparatus that evaluates radio signals from a radio system, such as e.g. via a GPS receiver. The position ascertained using the position finding apparatus is in this case checked in the device to determine whether this position is in a predetermined area. Only if this is the case is the device as a whole or particular functionalities of the device activated.

Geofencing allows e.g. rented construction machines to be used only in an admissible manner. Further applications are rental cars, transport of valuables and cash dispenser machines. Another effect that can be achieved with geofencing is that an encryption module is usable only in a particular area. Since radio signals and in particular GPS signals are forgeable by simple means, geofencing can be bypassed relatively simply, however.

Further, in satellite navigation systems, a receiver architecture is known in which the radio receiver detects the radio signals from the satellites, digitizes them and transmits a temporal radio signal section as what is known as a radio snippet (also referred to as a snippet) via a data communication network to a server for further processing. In this case, the position finding is no longer performed in the radio receiver itself but rather in the server, which provides the receiver with the ascertained position. Furthermore, there are approaches according to which cryptographically protected radio signals are transmitted in a satellite-based navigation system. The signals received in a radio receiver are in this case detected as raw data and forwarded as a radio snippet to a secure computer center via a data communication network. In the secure computer center, the cryptographically protected signal is processed further by executing cryptographic operations. As a result, no security-critical signal processing needs to take place on the radio receiver. The approach just described is pursued e.g. in the context of the PRS service (PRS=Public Regulated Service) of the Galileo satellite navigation system by the ULTRA project (see http://www.ultra-prs.eu/).

### SUMMARY

An aspect relates to providing a method and a system for activating functions in a radio receiver that reliably prevent improper activation of functions that are admissible only in particular regions or at particular times.

The method according to embodiments of the invention are used for activating functions in a radio receiver. Here and below, the term radio receiver is intended to be understood to mean that it is a device or object that contains a radio module for receiving radio signals, but may also have further functions that are not directly related to the radio reception. By way of example, a radio receiver may also be a mobile object, for example a construction machine or a motor vehicle having an appropriate radio module.

In a step a) of the method according to embodiments of the invention, the radio receiver detects a radio signal section by recording over a predetermined period one or more radio signals received by it from a radio system. In this case, the radio signal section has an associated piece of location and/or time information that represents the location of the radio receiver on reception of the radio signal(s) and/or the time of reception of the radio signal(s) in the radio receiver and that is ascertainable from the radio signal section. The time of reception can represent any time (including starting and ending times) within the radio signal section. The predetermined period of the recording of the radio signals is preferably in the range from a few milliseconds to a few tens of milliseconds.

The radio signals received by the radio receiver can originate from any radio system, provided that the radio signals allow localization or time determination. In a particularly preferred variant, the radio signals originate from a radio system in form of a satellite-based navigation system and the radio receiver contains a satellite signal receiver for the satellite based navigation system. Nevertheless, the radio system may possibly also comprise a wireless local area network, particularly a WLAN network, and/or a mobile radio system and/or a broadcast radio system. In this case, the radio receiver contains a receiver for WLAN signals and/or mobile radio signals and/or broadcast radio signals.

In a step b) of the method according to embodiments of the invention, the radio receiver converts the radio signal section into a communication signal that contains the radio signal section. In a variant, the recording of the radio signals involves the latter first of all being digitized, and subsequently a digital radio signal section is formed that is then converted into a format of a digital communication signal. In a modified variant, the radio signal section is detected as an analog signal as part of the recording, which analog signal is then converted into a digital communication signal. The radio receiver sends this communication signal by means of a suitable interface via a communication network to a server. Depending on the embodiment, the communication network may be configured differently in this case. In particular, the communication network may be a wired and/or wireless network. By way of example, the communication network can comprise the Internet and/or a mobile radio network. In particular, the communication network does not have to coincide with the radio system whose radio signals are recorded by the radio receiver.

In a step c) of the method according to embodiments of the invention, the transmitted communication signal is received via the communication network by the server, which uses the radio signal section in the communication signal to determine whether the piece of location and/or time information associated with the radio signal section is in an admissible value range. This value range may be stored e.g. in a database to which the server has access. The term admissible value range can be understood broadly. In particular, this value range may be a continuous range or possibly even a set of admissible values.

In a step d), the server sends an activation code via the communication network to the radio receiver if a number of criteria are satisfied, the number of criteria comprising the criterion that the associated piece of location and/or time information is in the admissible value range. The definition of the criterion (introduced by the word “that”) stipulates satisfaction of the criterion.

Finally, in a step e) of the method according to embodiments of the invention, the transmitted activation code is received via the communication network by the radio receiver, whereupon activation of one or more functions is initiated in the radio receiver. If need be, the activation can be caused only for a predetermined period, the activation being disabled again by the radio receiver after the period has elapsed.

The method according to embodiments of the invention are distinguished in that the check on the reliability of a piece of location or time information to which the use of functions in a radio receiver is coupled is relocated to a separate server that communicates with the radio receiver. In this way, local manipulations on the radio receiver for the purpose of activating functions without authorization are prevented. Instead, activation is effected only on reception of an activation code that is provided from outside the radio receiver.

In a particularly preferred variant of the method according to embodiments of the invention, the communication signal further contains an identification of the radio receiver, wherein the server reads the identification and, when determining whether the associated piece of location and/or time information is in the admissible value range, uses a value range associated with the identification and/or wherein the server determines the activation code on the basis of the identification of the radio receiver. In this way, the activation of functions can be stipulated on a device-specific basis.

In a particularly preferred variant of the method according to embodiments of the invention, the server computes the associated piece of location and/or time information (directly) from the radio signal section that the communication signal received by it contains. Subsequently, the server compares the computed piece of location and/or time information with the admissible value range.

In a further variant of the method according to embodiments of the invention, the server compares the radio signal section that the communication signal received by it contains with a set of predetermined radio signal sections that each have an associated piece of location and/or time information in the admissible value range. A sufficient match between the radio signal section that the communication signal received by the server contains and a predetermined radio signal from the set of predetermined radio signals prompts the determination that the piece of location and/or time information associated with the radio signal section is in the admissible value range. In this case, a sufficient match between the radio signal sections may be stipulated e.g. by virtue of the similarity between the radio signal sections exceeding a predetermined extent. Corresponding methods of stipulating similarities between signals are known in this case or are within the scope of action of a person skilled in the art. By way of example, this can be accomplished by performing a correlation between the signals.

In a further, particularly preferred embodiment, the radio signal section contains cryptographically protected radio signals (e.g. encrypted radio signals). In this case, the server, as part of the determination of whether the piece of location and/or time information associated with the radio signal section is in an admissible value range, performs a cryptographic operation on the radio signal (e.g. decryption or correlation with a cryptographically generated code, e.g. a cryptographic spreading code) that lifts the cryptographic protection of the radio signals (particularly by means of a cryptographic key). According to this embodiment, security-critical functionalities are relocated from the radio receiver to the server, which increases the security of the method. Further, radio receivers of simple design and inexpensive radio receivers can be used that do not need to perform complex cryptographic operations.

In a further variant of the method according to embodiments of the invention, the number of criteria comprises, besides the criterion that the associated piece of location and/or time information is in an admissible range, one or more of the following criteria:
the criterion that the age of the radio signal section, according to the piece of time information associated therewith, is below a predetermined threshold value;
the criterion that the radio signal section satisfies one or more plausibility conditions, particularly in relation to an expected attenuation and/or distortion and/or signal strength of the radio signals recorded in the radio signal section.

The corresponding definition of the respective criterion (introduced by the word “that”) stipulates satisfaction of the criterion. The above criterion of the age of the radio signal section ensures that functions are only ever activated on the basis of current radio signals. The above criterion relating to the plausibility conditions further increases the security of the method against manipulations, e.g. by forged radio signals. Appropriate methods for checking the plausibility of signals are known per se from the known art. As mentioned, it is possible to check e.g. whether an expected attenuation or distortion in the radio signal arises that is caused, in the case of satellite signals, e.g. on passage through the ionosphere. Such attenuations and distortions are not normally contained in forged satellite signals. Furthermore, the plausibility of signal noise or of the absolute signal strength or of the relative signal strength of the radio signals can also be checked.

The activation code transmitted by the server as part of the method according to embodiments of the invention may be configured differently. In particular, the activation code can comprise a numerical and/or alphanumeric and/or binary code and/or a cryptographic key. Preferably, the activation code has a predetermined validity period that is checked by the radio receiver. Only when the validity period has not expired is activation of the function(s) initiated in the radio receiver. Preferably, further, activation of the function(s) is disabled by the radio receiver after the validity period has expired. If need be, the activation code can also comprise a reference to the radio signal section that has been received by the server in step c), wherein only if the radio receiver can associate the reference with a radio signal section transmitted by it is activation of the function(s) initiated in the radio receiver.

The function(s) to be activated in the radio receiver may be stipulated differently depending on the configuration. In particular, the functions comprise one or more of the following functions:
the reproduction of a medium by the radio receiver, such as e.g. the reproduction of a DVD or of a Blu-ray disk;
a cryptographic function of a cryptographic module in the radio receiver, such as e.g. a crypto token, a TPM module (TPM=Trusted Platform Module) or a hardware security module;
the local decryption of cryptographically encrypted data in the radio receiver;
the lifting of a movement barrier for the radio receiver, such as e.g. an immobilizer for a mobile object;
the performance of a configuration for the radio receiver;
the function of a remote activation, caused by the radio receiver, of one or more functions in a device communicating with the radio receiver.

The activation of the functions in the device communicating with the radio receiver can relate to the functions already cited above, i.e. the reproduction of a medium, the cryptographic function of a cryptographic module, the decryption of cryptographically encrypted data, the lifting of a movement barrier and the performance of a configuration. However, these functions now do not relate to the radio receiver, but rather are functions of the device communicating with the radio receiver. If need be, the function to be activated may also be the display of the activation code on a display in the radio receiver. In one application scenario, the activation code can then be read off by a user and input using an appropriate user interface on the radio receiver in order to thereby activate further functions in the radio receiver.

To increase the security of the method, the communication signal and/or the activation code is/are preferably transmitted via a cryptographically protected communication link between the radio receiver and the server via the communication network (e.g. on the basis of IPsec, SSL, TLS).

An activation code may be e.g. a single bit that encodes activation (or no activation). Preferably, the activation code is a bit sequence, a password, a PIN, a license code or a cryptographic key. In a preferred variant, the activation code is used by the receiver in a cryptographic operation. As such, it is possible e.g. for the activation code or a portion of the activation code to be used as a cryptographic key or as a key derivation parameter, or it is possible for the validity thereof to be checked by means of a cryptographic key of the receiver. An activation code can comprise further information, e.g. the duration of the activation, the starting time of the activation, an ending time of the activation, an indication of functions to be activated from a set of activable functions. The receiver performs activation in accordance with the indicated restrictions. This means that activation is effected e.g. only for a limited time or that only a subset of activable functions is activated by an activation code.

Besides the method described above, embodiments of the invention further relates to a system comprising radio receiver and server, wherein the radio receiver and the server are set up for performing the method according to embodiments of the invention or one or more preferred variants of the method according to the invention.

Embodiments of the invention relate furthermore to a radio receiver that is set up for use in the system just described. This radio receiver comprises:
a means for detecting a radio signal section by recording over a predetermined period one or more radio signals received by the radio receiver from a radio
system, wherein the radio signal section has an associated piece of location and/or time information that represents the location of the radio receiver on reception of the radio signal(s) and/or the time of reception of the radio signal(s) and that is ascertainable from the radio signal section;
a means for converting the radio signal section into a communication signal that contains the radio signal section, and a means for transmitting this communication signal via a communication network to a server;
a means for receiving an activation code that is transmitted by the server via the communication network to the radio receiver and for subsequently initiating activation of one or more functions in the radio receiver.

The radio receiver can also include, in the form of corresponding apparatus features, such features of embodiments of the method according to embodiments of the invention as relate to the radio receiver.

Embodiments of the invention relates furthermore to a server that is set up for use in the system described above. In this case, the server comprises:
a means for receiving a communication signal transmitted by a radio receiver via a communication network, wherein the communication signal contains a radio signal section that is a recording of one or more radio signals received by the radio receiver from a radio system over a predetermined period, wherein the radio signal section has an associated piece of location and/or time information that represents the location of the radio receiver on reception of the radio signal(s) and/or the time of reception of the radio signal(s) and that is ascertainable from the radio signal section;
a means for using the radio signal section in the received communication signal to determine whether the
piece of location and time information associated with the radio signal section is in an admissible value range;
a means for transmitting an activation code via the communication network to the radio receiver if a number of criteria are satisfied, the number of criteria comprising the criterion that the associated piece of location and time information is in the admissible value range.

The server can contain, in the form of corresponding apparatus features, such features of preferred embodiments of the method according to the invention as relate to the server.

### BRIEF DESCRIPTION

Some of the embodiments will be described in detail, with reference to the following FIGURE, wherein like designations denote like members, wherein:

The FIGURE depicts the activation of a radio receiver.

### DETAILED DESCRIPTION

In the exemplary embodiment of The FIGURE, a functionality is activated in the radio receiver RX on the basis of the geographical location of the radio receiver. Alternatively or additionally, it may also be possible to take into consideration a piece of time information for activating functions in the radio receiver. The radio receiver is any device or object having a reception function for corresponding radio signals. In particular, the radio receiver may be a mobile object, such as e.g. a vehicle or a construction machine, that is intended to be prevented from being used inadmissibly outside particular areas, e.g. outside a particular building site.

The radio receiver RX communicates with a radio system RAS, which may be any radio system whose radio signals allow the radio receiver RX to be located. By way of example, the two satellites SA indicate a satellite-based radio system, the base stations BS indicate a WLAN-based radio system and the base station BS' indicates a mobile radio system or a broadcast radio system. An embodiment of the invention is described below based on a radio receiver that receives the signals from a satellite-based navigation system, such as e.g. GPS, Glonass, Galileo and the like. In a manner known per se, the satellites of the navigation system transmit a radio signal that is received by the radio receiver RX. The PRN code modulated on from the respective satellite can be used to determine the propagation time of the signal and hence a piece of distance information. If at least the signals from four satellites are received in the radio receiver, it is possible for the position of the receiver and the time to be computed. In variants embodiments of the invention in which only a piece of time information is needed, it is sufficient for the receiver to receive the signal from one satellite.

In The FIGURE, the radio signals transmitted by the satellite navigation system are indicated by SI. It is assumed that the receiver RX receives the signals from at least four satellites, so that these can be used to compute its geographical position. In the receiver RX, the activation of particular functions is coupled to whether the radio receiver is in a particular geographical area. Conventionally, the receiver itself ascertains its position and then infers therefrom whether this position is in the predetermined geographical area. If this is not the case, then the function is not activated. By contrast, according to embodiments of the invention, the functionality of position finding for the receiver and determination of whether this position is in a predetermined geographical area is performed by a separate license server LS. This license server can communicate with the radio receiver RX via a communication network NE. The communication network may be configured arbitrarily, in particular it is possible for the network to comprise a mobile radio network and/or the Internet and the like.

The radio receiver RX initially records the radio signals SI received by it for a predetermined period. The period is in the region of a few milliseconds. The recorded satellite signals are also referred to as radio signal sections or snippets or radio snippets below and are represented by the reference symbol RS in The FIGURE. These radio snippets are initially available in analog form. For transmission to the license server LS, they are digitized and transmitted together with an explicit device identification ID of the radio receiver RX as a digital communication signal KS to the license server LS.

In the license server LS, the evaluation of the communication signal KS is effected. To this end, the radio signal section RS is extracted from the communication signal KS and processed further in a manner known per se in order to ascertain the geographical position of the receiver RX therefrom. Subsequently, this position is compared with an admissible geographical area that is specific to the device identification ID. The geographical area may in this case be stored in a database of the license server, or the license server accesses a remote database for this purpose. If the position obtained from the radio snippet RS is in the admissible area, then the license server produces an activation code AC specific to the radio receiver RS. It can read this e.g. from a database or compute it in a suitable manner using a security module. The activation code AC is subsequently transmitted via the communication network NE to the radio receiver RX. Reception of the activation code communicates to the receiver RX that one or more functionalities can be activated in the receiver. Accordingly, activation of the functionalities is performed.

The activation code transmitted from the license server to the radio receiver RX may be configured differently. By way of example, it may be a PIN or another code for activating a security module in the radio receiver. Similarly, the activation code may be a cryptographic key that the radio receiver uses e.g. for decrypting data stored on it (e.g. program code, user data and the like). Similarly, the activation code can contain configuration data that are subsequently used to configure the radio receiver.

In a further application scenario, the radio receiver contains the function of what is known as a “cognitive radio”, in the case of which the radio receiver can adaptively use unused frequency bands for data transmission. In this case, the activation code can indicate e.g. what transmission power, what modulation methods and what frequency bands can be used. In this context, the activation code causes the activation of a function that is used to stipulate frequency bands to be used for a cognitive radio. By virtue of suitable stipulation of the geographical region in which this function is intended to be activated, it is possible to take into consideration that frequency bands are provided for official purposes in some regions or countries and cannot be used otherwise, whereas in other regions it is possible for such bands to be used for cognitive radio.

In a further preferred embodiment, a fixed or possibly even prescribable period of use is provided for the activation code. After the period of use has expired, the code is disabled or erased by the radio receiver. It is also possible for the activation code to comprise a piece of information about its validity period. By virtue of the method described above being repeated, it is possible for the radio receiver to be activated again using a new activation code after the validity period has expired, or for particular functions not to be disabled.

The embodiments of the method according to the invention that are described above have a series of advantages. In particular, inadmissible use of the radio receiver is reliably prevented by virtue of the check to determine whether the activation of a function in the radio receiver is admissible being performed by a separate license server. Successful manipulation by means of what is known as a GPS spoofer, which feigns a position other than the actual one for the radio receiver, is much more difficult to implement in this case. In particular, it is possible to implement complex methods in the license server in order to identify GPS spoofers. Such methods cannot be put into action on a standard commercial radio receiver. Furthermore, the evaluation algorithms for checking a radio signal section can be adapted in the license server in a simple manner on the basis of manipulations observed in practice in order to prevent future similar manipulations.

It is also possible for a license server to process different radio signal sections, which may possibly be evaluable only in a complex fashion. In particular, said license server can evaluate e.g. encrypted satellite navigation signals that the radio receiver cannot decrypt itself owing to a lack of resources. Such satellite signals are intended to be used e.g. by the satellite-based navigation service Galileo PRS. Since the radio receiver itself does not have to determine its own position, but rather only records and transmits a radio snippet, the implementation complexity in the radio receiver is low. In particular, the radio receiver also does not have to contain mechanisms to protect the determination of its position against manipulations.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for activating functions in a radio receiver, in which
a) the radio receiver detects a radio signal section by recording over a predetermined period one or more radio signals received by it from a radio system, wherein the radio signal section has an associated piece of location and/or time information that represents the location of the radio receiver on reception of the radio signal(s) and/or the time of reception of the radio signal(s) and that is ascertainable from the radio signal section;
b) the radio receiver converts the radio signal section into a communication signal that contains the radio signal section, and transmits this communication signal via a communication network to a server;
c) the transmitted communication signal is received via the communication network by the server, which uses the radio signal section in the communication signal to determine whether the piece of location and/or time information associated with the radio signal section is in an admissible value range;
d) the server transmits an activation code via the communication network to the radio receiver if a number of criteria are satisfied, the number of criteria comprising the criterion that the associated piece of location and/or time information is in the admissible value range;
e) the transmitted activation code is received via the communication network by the radio receiver, whereupon activation of one or more functions is initiated in the radio receiver.

2. The method as claimed in claim 1, wherein the radio system comprises a satellite-based navigation system and the radio receiver contains a satellite signal receiver for the satellite-based navigation system.

3. The method as claimed in claim 1, wherein the radio system comprises a wireless local area network, particularly a WLAN network, and/or a mobile radio system and/or a broadcast radio system and the radio receiver contains a receiver for WLAN signals and/or mobile radio signals and/or broadcast radio signals.

4. The method as claimed in claim 1, wherein the communication signal further contains an identification of the radio receiver, wherein the server reads the identification and, when determining whether the associated piece of location and/or time information is in the admissible value range, uses a value range associated with the identification and/or wherein the server determines the activation code on the basis of the identification of the radio receiver.

5. The method as claimed in claim 1, wherein the server computes the associated piece of location and/or time information from the radio signal section that the communication signal received by it contains and compares the computed piece of location and/or time information with the admissible value range.

6. The method as claimed in claim 1, wherein the server compares the radio signal section that the communication signal received by it contains with a set of predetermined radio signal sections that each have an associated piece of location and/or time information in the admissible value range, wherein a sufficient match between the radio signal section that the communication signal received by it contains and a predetermined radio signal prompts the determination that the piece of location and/or time information associated with the radio signal section, is in the admissible value range.

7. The method as claimed in claim 1, wherein the radio signal section contains cryptographically protected radio signals and the server, as part of the determination of whether the piece of location and/or time information associated with the radio signal section is in an admissible value range, performs a cryptographic operation on the radio signal section that lifts the cryptographic protection of the radio signals.

8. The method as claimed in claim 1, wherein the number of criteria further comprises one or more of the following criteria: the criterion that the age of the radio signal section, according to the piece of time information associated therewith, is below a predetermined threshold value; the criterion that the radio signal section satisfies one or more plausibility conditions, particularly in relation to an expected attenuation and/or distortion and/or signal strength of the radio signals recorded in the radio signal section.

9. The method as claimed in claim 1, wherein the activation code has a predetermined validity period, wherein only when the validity period has not expired is activation of the function(s) initiated in the radio receiver, and/or in that the activation code comprises a reference to the radio signal section that was received by the server in step c), wherein only if the radio receiver can associate the reference with a radio signal section transmitted by it beforehand is activation of the function(s) initiated in the radio receiver.

10. The method as claimed in claim 1, wherein the function(s) to be activated comprise(s) one or more of the following functions: the reproduction of a medium by the radio receiver; a cryptographic function of a cryptographic module in the radio receiver; the decryption of cryptographically encrypted data in the radio receiver; the lifting of a movement barrier for the radio receiver; the performance of a configuration for the radio receiver; the function of a remote activation, caused by the radio receiver, of one or more functions in a device communicating with the radio receiver.

11. The method as claimed in claim 1, wherein the communication signal and/or the activation code is/are transmitted via a cryptographically protected communication link between the radio receiver and the server via the communication network.

12. A system comprising a radio receiver and server, wherein the radio receiver and the server are set up to perform a method, in which:
a) the radio receiver detects a radio signal section by recording over a predetermined period one or more radio signals received by it from a radio system, wherein the radio signal section has an associated piece of location and/or time information that represents the location of the radio receiver on reception of the radio signal(s) and/or the time of reception of the radio signal(s) and that is ascertainable from the radio signal section;
b) the radio receiver converts the radio signal section into a communication signal that contains the radio signal section, and transmits this communication signal via a communication network to a server;
c) the transmitted communication signal is received via the communication network by the server, which uses the radio signal section in the communication signal to determine whether the piece of location and/or time information associated with the radio signal section is in an admissible value range;
d) the server transmits an activation code via the communication network to the radio receiver if a number of criteria are satisfied, the number of criteria comprising the criterion that the associated piece of location and/or time information is in the admissible value range;
e) the transmitted activation code is received via the communication network by the radio receiver, whereupon activation of one or more functions is initiated in the radio receiver.

13. A system comprising a radio receiver and server, wherein the radio receiver and the server are set up to perform a method, in which: the method is the method claimed in claim 2.

14. A radio receiver that is set up for use in a system as claimed in claim 12, wherein the radio receiver comprises:
a means for detecting a radio signal section by recording over a predetermined period one or more radio signals received by the radio receiver from a radio system, wherein the radio signal section has an associated piece of location and/or time information that represents the location of the radio receiver on reception of the radio signal(s) and/or the time of reception of the radio signal(s) and that is ascertainable from the radio signal section;
a means for converting the radio signal section into a communication signal that contains the radio signal section, and a means for transmitting this communication signal via a communication network to a server;
a means for receiving an activation code that is transmitted by the server via the communication network to the radio receiver and for subsequently initiating activation of one or more functions in the radio receiver.

15. A server that is set up for use in a system as claimed in claim 12, wherein the server comprises:
a means for receiving a communication signal transmitted by a radio receiver via a communication network, wherein the communication signal contains a radio signal section that is a recording of one or more radio signals received by the radio receiver from a radio system over a predetermined period, wherein the radio signal section has an associated piece of location and/or time information that represents the location of the radio receiver on reception of the radio signal(s) and/or the time of reception of the radio signal(s) and that is ascertainable from the radio signal section;
a means for using the radio signal section in the received communication signal to determine whether the piece of location and/or time information associated with the radio signal section is in an admissible value range;
a means for transmitting an activation code via the communication network to the radio receiver if a number of criteria are satisfied, the number of criteria comprising the criterion that the associated piece of location and/or time information is in the admissible value range.
